(19) United States
(12) Patent Application Publication
(10) Pub. No.: US 2004/0156324 A1
(43) Pub. Date: Aug. 12, 2004

(54) Method and arrangement for increasing the versatility of compressed mode for inter-system measurements

(76) Inventor: Ville Steudle, Turku (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/468,921

(22) PCT Filed: Feb. 18, 2002
(86) PCT No.: PCT/FI02/00131

(30) Foreign Application Priority Data
Feb. 20, 2001 (FI) 20010324

(51) Int. Cl. H04B 7/005

(52) U.S. Cl. 370/278; 370/342

(57) ABSTRACT

A method and arrangements are disclosed for indicating (408, 609) the timing of a transmission gap pattern sequence to a mobile terminal of a cellular radio system. There are indicated (408, 609) the starting moment (TGCFN) of the transmission gap pattern sequence, the total number of occurrences (#TGPRC) of transmission gap patterns in the transmission gap pattern sequence, the lengths of certain first (TGPL1) and second (TGPL2) transmission gap patterns that are to occur during the transmission gap pattern sequence, and the lengths of transmission gaps (TGL1, TGL2) to be located within the first and second transmission gap patterns. Additionally there are indicated (408, 609) at least three of the following independently of each other: the distance (TGSN1) between the beginning of the first transmission gap pattern and the beginning of a temporally first transmission gap within the first transmission gap pattern, the distance (TGSN2) between the beginning of the second transmission gap pattern and the beginning of a temporally first transmission gap within the second transmission gap pattern, the distance (TGD1) between the beginnings of certain temporally first and temporally second transmission gaps within the first transmission gap pattern, and the distance (TGD2) between the beginnings of certain temporally first and temporally second transmission gaps within the second transmission gap pattern.

### CROSS-REFERENCE TO RELATED APPLICATION

This application is the national phase of International Application PCT/FI02/00131, filed 18 Feb. 2002 that was published in English 29 Aug. 2002 under International Publication Number WO 02/067458 and claims priority from Finnish Application 20010324, filed 20 Feb. 2001.

### BACKGROUND OF THE INVENTION

1. Technical Field

The invention concerns generally the timing of transmission and reception in cellular radio systems. Especially the invention concerns the problem of exactly how should the mobile terminals operating in cellular radio system be arranged to use a so-called compressed mode where reception and transmission are repeatedly interrupted for performing measurements directed to other cellular radio systems. This patent application uses the term “mobile terminal” generally to refer to all terminals of all cellular radio systems, regardless of their potential alternative names such as user equipment, mobile part, or mobile station.

2. Discussion of Related Art

In order to be constantly prepared for potential handovers the mobile terminal must evaluate the available target frequencies in terms of connection quality that it could achieve on them. This in turn necessitates that the mobile terminal must quickly tune its radio receiver (or one of its radio receivers, in case it comprises several of them) onto each target frequency to be evaluated for a certain period of time. In TDMA (Time Division Multiple Access) systems this is not a problem since the mobile terminal must anyway transmit and receive only during certain cyclically occurring time intervals, between which it has time to tune its receiver onto whatever other frequencies it wants. However, in other systems like CDMA (Code Division Multiple Access) where reception and transmission are essentially continuous it may be problematic to find suitable time intervals for the measurements.

It is known to define and employ a so-called slotted mode or compressed mode for transmission and reception in order to leave certain time intervals free for measurement purposes. In this patent application we use the term compressed mode to mean that both transmission and reception are not continuous as usual but performed only according to a certain predefined gap pattern. In a single-receiver station compressed receiving is essential in order to reserve the receiver to the use of the ongoing connection for only a part of the time. Compressed transmitting is not that essential at first sight, but usually it is unavoidable since the transmitter must be powered down for those time periods when the receiver is measuring. Leakage power from the transmitter might easily interfere with an ongoing measurement in the receiver.

Compressed mode is not without problems from the system point of view. Higher transmission power must be used in compressed mode than in continuous mode, since the closed-loop power control between the base station and the mobile terminal is not functioning properly and since the same amount of information must be sent in a shorter time. CDMA systems are extremely sensitive to increasing transmission power, because all simultaneously ongoing transmissions cause interference to each other. Additionally ensuring optimal timing for the compressed mode of a mobile terminal may require a considerable amount signalling between a network element in the radio access network and the mobile terminal, at least if there are numerous other base stations to be measured that belong to a different cellular network than the base station with which the mobile terminal is currently communicating.

FIG. 1 illustrates the last-mentioned problem when compressed mode is used in the form defined in the 3GPP (3^{rd} Generation Partnership Project) technical specification number TS 25.215 at the priority date of this patent application. This specification is to be applied in the FDD (Frequency Division Duplex) part of the UTRA (UMTS Terrestrial Radio Access; Universal Mobile Telecommunications System).

A transmission gap pattern sequence is defined to consist of two TGPs (Transmission Gap Patterns) that are repeated alternatedly. Each occurrence of a TGP is numbered (#1, #2, #3, #4, #5 . . . ) and the number of TGPs in a certain transmission gap pattern sequence is finite so that the number of the last occurrence of a TGP in the sequence is TGPRC (Transmission Gap Pattern Repetition Count). The beginning of the sequence coincides with a connection frame number given as TGCFN (Transmission Gap Connection Frame Number). The alternated first and second TGPs may have different lengths that are given as TGPL1 and TGPL2 (Transmission Gap Pattern Length 1 and 2) and are expressed in number of frames. Within each TGP the values of TGSN, TGL1, TGL2 and TGD are the same. The definitions of these are:

TGSN (Transmission Gap Starting slot Number): the slot number of the first transmission gap slot within the first radio frame of the transmission gap pattern,

TGL1 (Transmission Gap Length 1): the duration of the first transmission gap within the transmission gap pattern, expressed in number of slots,

TGL2 (Transmission Gap Length 2): the duration of the second transmission gap within the transmission gap pattern, expressed in number of slots and equal to TGL1 if not explicitly stated otherwise,

TGD (Transmission Gap Distance): the duration between the starting slots of two consecutive transmission gaps within a transmission gap pattern, expressed in number of slots; if not given there is no second gap within the transmission gap pattern.

In order to completely define a single transmission gap pattern sequence, the above-introduced parameters (TGSN, TGL1, TGL2, TGD, TGPL1, TGPL2, TGPRC and TGCFN) must all be signalled to a mobile terminal. The required signalling effort becomes even more prominent if one tries to minimize the overall duration of compressed mode while simultaneously ensuring maximal number of coincidences between transmission gaps and BSIC (Base Station Identity Code) transmissions from nearby base stations of the GSM (Global System for Mobile telecommunications). The latter occur in frames 1, 11, 21, 31 and 41 of the GSM multiframe structure, and in an optimal case a UTRAN (UTRA Network) is assumed to know the expected occurrences of BSIC transmissions from nearby GSM base stations. There is no integer relation between the GSM frame length (4.615 ms) and the UTRA FDD frame length (10 ms). When the UTRAN determines the timetable of a certain transmission gap pattern sequence, it can only select freely (at the resolution of FDD slot, which is 667 microseconds) the occurrence of two gaps: those that occur during the first TGP of the sequence. All other gaps in the sequence occur at integer numbers of frames after the first two gaps. In order to ensure coincidences between transmission gaps and BSIC transmissions the UTRAN must compose a number of consecutively applicable transmission gap pattern sequences which all must be signalled to the mobile terminal. An alternative option would be to make a transmission gap pattern sequence relatively long, so that the non-integer relations between GSM and UTRAN frame timing would cause coincidences to occur. This is undesirable, because the overall interference caused to other simultaneous connections would increase.

Mobile terminals may need to receive the BSIC transmissions for two purposes: for initial BSIC identification or for BSIC reconfirmation. The compressed mode arrangements discussed in this patent application are mainly related to the latter. However, in order not to obscure the general applicability of the invention, we will simply refer to receiving BSIC transmissions.

### DISCLOSURE OF INVENTION

It is an object of the present invention to provide a method and an arrangement for determining the timing of compressed mode so that optimality is approached both in short duration of compressed mode and in frequent coincidences between transmission gaps in compressed mode and known occurrences of expected transmissions from other base stations.

The objects of the invention are achieved by allowing selectability to the values of certain additional parameters that are related to the timetables of compressed mode, and signalling also the values of these parameters to the mobile terminal.

According to a first aspect of the invention, a method for indicating the timing of a transmission gap pattern sequence to a mobile terminal of a cellular radio system comprising the steps of indicating a starting moment of the transmission gap pattern sequence, indicating a total number of occurrences of transmission gap patterns in the transmission gap pattern sequence, indicating lengths of certain first and second transmission gap patterns that are to occur during the transmission gap pattern sequence, and indicating lengths of transmission gaps to be located within the first and second transmission gap patterns, is characterized in that it comprises the step of indicating three of the following independently of each other: a) a distance between a beginning of the first transmission gap pattern and a beginning of a temporally first transmission gap within the first transmission gap pattern, b) a distance between a beginning of the second transmission gap pattern and a beginning of a temporally first transmission gap within the second transmission gap pattern, c) a distance between beginnings of certain temporally first and temporally second transmission gaps within the first transmission gap pattern, and d) a distance between beginnings of certain temporally first and temporally second transmission gaps within the second transmission gap pattern.

The invention applies also to an arrangement for defining the timing of a transmission gap pattern sequence for a mobile terminal of a cellular radio system, and to an arrangement for observing the timing of a transmission gap pattern sequence in a mobile terminal of a cellular radio system

According to a second aspect of the present invention, an arrangement for defining timing of a transmission gap pattern sequence for a mobile terminal of a cellular radio system comprising means for defining a starting moment of the transmission gap pattern sequence, means for defining a total number of occurrences of transmission gap patterns in the transmission gap pattern sequence, means for defining lengths of certain first and second transmission gap patterns that are to occur during the transmission gap pattern sequence, and means for defining lengths of transmission gaps to be located within the first and second transmission gap patterns is characterized in that it comprises means for defining at least three of the following independently of each other: a) distance between a beginning of the first transmission gap pattern and a beginning of a temporally first transmission gap within the first transmission gap pattern, b) distance between a beginning of the second transmission gap pattern and a beginning of a temporally first transmission gap within the second transmission gap pattern, c) distance between beginnings of certain temporally first and temporally second transmission gaps within the first transmission gap pattern, and d) distance between beginnings of certain temporally first and temporally second transmission gaps within the second transmission gap pattern.

According to a third aspect of the present invention, an arrangement for observing timing of a transmission gap pattern sequence in a mobile terminal of a cellular radio system comprising means for observing a starting moment of the transmission gap pattern sequence, means for observing a total number of occurrences of transmission gap patterns in the transmission gap pattern sequence, means for observing lengths of certain first and second transmission gap patterns that are to occur during the transmission gap pattern sequence, and means for observing lengths of transmission gaps to be located within the first and second transmission gap patterns is characterized in that it comprises means for observing at least three of the following independently of each other: a) a distance between a beginning of the first transmission gap pattern and a beginning of a temporally first transmission gap within the first transmission gap pattern, b) a distance between a beginning of the second transmission gap pattern and a beginning of a temporally first transmission gap within the second transmission gap pattern, c) a distance between beginnings of certain temporally first and temporally second transmission gaps within the first transmission gap pattern, and d) a distance between beginnings of certain temporally first and temporally second transmission gaps within the second transmission gap pattern.

The inflexibility of the known method and arrangement for placing the gaps within the timetable of a transmission gap pattern sequence is a consequence of the fixed, repeated occurrence of certain parameter-defined intervals in the sequence. Another cause of inflexibility is the coarse resolution of 10 ms in the value space of certain parameters. In the present invention it has been found that remarkable enhancements in flexibility can be achieved by allowing the values of certain parameters to change between the alternated transmission gap patterns instead of keeping them fixed.

Especially in the UTRA FDD example described as prior art, it has been found that the invariability of the TGSN and TGD parameters between the first and second transmission gap patterns causes inflexibility. According to the invention the TGSN and TGD parameters as they were previously known are renamed as TGSN1 and TGD1 to explicitly point out that they only apply to the first transmission gap pattern. Simultaneously two new parameters, designated as TGSN2 and TGD2 are introduced. Of these, TGSN2 shall denote the slot number of the first transmission gap slot within the first radio frame of the second transmission gap pattern and TGD2 shall denote the duration between the starting slots of two consecutive transmission gaps within the second transmission gap pattern.

When a network element that applies the present invention is aware of the timing of expected base station identity transmissions from nearby base stations other than that currently communicating with a mobile terminal, it calculates a timetable for transmission gaps so that even a maximum of four gaps coincide with expected base station identity transmissions. It then translates the calculated timetable into a transmission gap pattern sequence so that said four gaps occur in two consecutive transmission gap patterns. As a generalization the invention may be applied so that said four gaps occur in two transmission gap patterns that are as close as possible to each other in said transmission gap pattern sequence. The network element signals the resulting transmission gap pattern sequence to the mobile terminal, which executes it and utilizes the transmission gaps to intercept the base station identity transmissions in question. If there are more than four base station identity transmissions to be received by that mobile terminal or if the first opportunity was not enough for successful reception of the base station identity transmissions, the network element may repeat the procedure until the mobile terminal has received all required base station identity transmissions.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 illustrates the known use of parameters in timing a transmission gap pattern sequence,

FIG. 2 illustrates the use of parameters in timing a transmission gap pattern sequence according to an embodiment of the invention,

FIG. 3 illustrates certain relations between timing parameters and transmissions to be received,

FIG. 4 illustrates a method according to the embodiment described in FIG. 2,

FIG. 5 illustrates the use of parameters in timing a transmission gap pattern sequence according to another embodiment of the invention,

FIG. 6 illustrates a method according to the embodiment described in FIG. 5,

FIG. 7 illustrates a radio network controller according to the invention and

FIG. 8 illustrates a mobile terminal according to the invention.

### BEST MODE FOR CARRYING OUT THE INVENTION

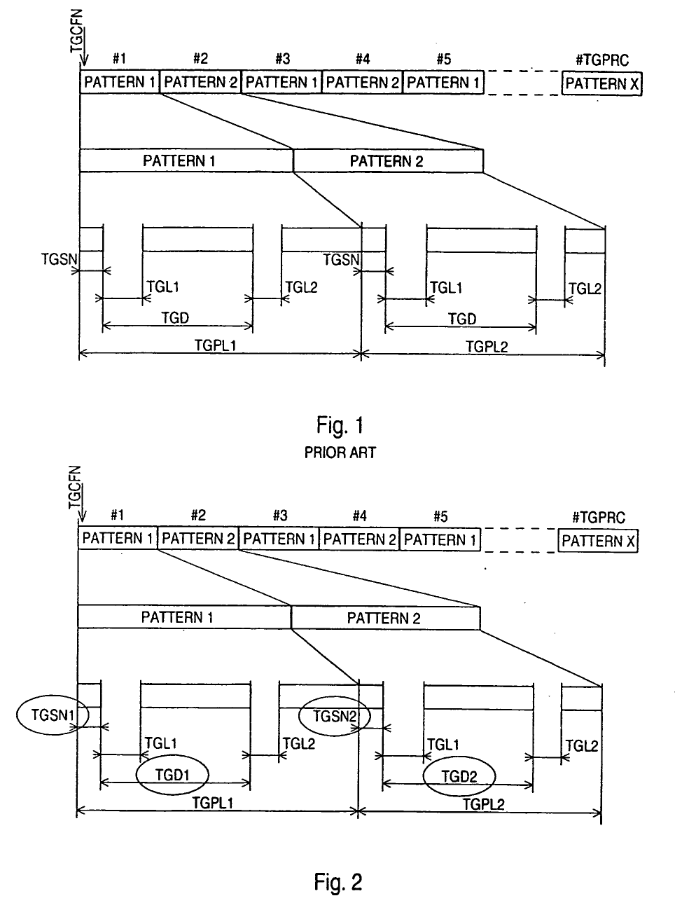

In FIG. 2 the concepts of transmission gap pattern sequence, first transmission gap pattern and second transmission gap pattern are used basically in the same way as above in the description of prior art and FIG. 1: the transmission gap pattern sequence comprises alternating, numbered occurrences of the first and second transmission gap patterns so that the numbering illustrated as #1, #2, #3, #4, #5 ends at the maximum repetition count #TGPRC. Note that the smallest possible value of #TGPRC is 1, meaning that the transmission gap pattern sequence may comprise a single occurrence of the first transmission gap pattern. In the following we will especially consider cases where the value of #TGPRC is 2, meaning that the transmission gap pattern sequence comprises single occurrences of both the first and the second transmission gap patterns. The start of the transmission gap pattern sequence is denoted by the parameter TGCFN as in the prior art arrangement.

The differences of FIG. 2 to the prior art arrangement are at the circled locations. A parameter TGSN1 denotes the slot number of the first transmission gap slot within the first radio frame of the first transmission gap pattern, and a parameter TGSN2 denotes the slot number of the first transmission gap slot within the first radio frame of the second transmission gap pattern. A parameter TDG1 denotes the duration between the starting slots of two consecutive transmission gaps within the first transmission gap pattern, and a parameter TDG2 denotes the duration between the starting slots of two consecutive transmission gaps within the second transmission gap pattern. The values of parameters TGD1 and TGD2 are expressed in number of slots.

The rest of the parameter values shown in FIG. 2 have the same meaning as in FIG. 1: TGL1 (Transmission Gap Length 1) and TGL2 (Transmission Gap Length 2) denote the durations of the first and second transmission gaps within the transmission gap patterns respectively, expressed in number of slots. The value of TGL2 is equal to that of TGL1 if not explicitly stated otherwise. The alternated first and second transmission gap patterns may have different lengths that are given as TGPL1 and TGPL2 (Transmission Gap Pattern Length 1 and 2) and are expressed in number of frames; again the value of TGPL2 is equal to that of TGPL1 if not explicitly stated otherwise.

Let us assume that a network element in a UTRAN is aware of the timing of expected BSIC transmissions from nearby GSM base stations. The BSIC transmissions of a single GSM base station occur in frames 1, 11, 21, 31 and 41 of the GSM multiframe structure having 51 frames altogether, so with the exception of those BSIC transmissions that occur in the 41st frame of a certain Nth multiframe and the 1st frame of the (N+1)th multiframe the separation in time of two consecutive BSIC transmissions is 46.15 ms. The longer separation referred to above is 50.77 ms, so roughly we may say that if a certain period of 50 ms is fixed in time, we may always choose a BSIC transmission from a certain GSM base station so that it occurs during said fixed 50 ms period. Note that 50 ms corresponds to exactly five UTRA FDD frames.

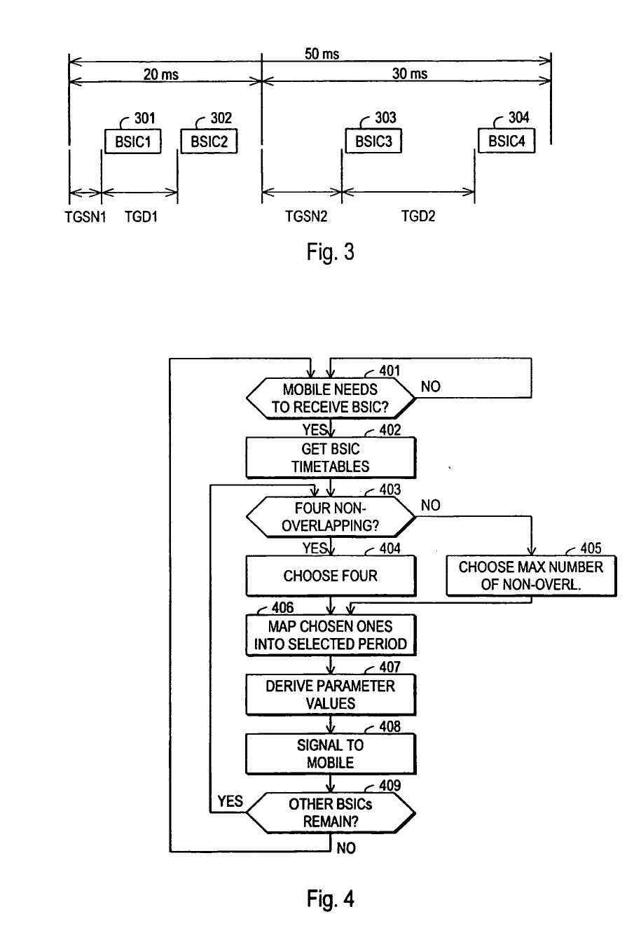

Next, let us assume that there are four GSM base stations, each making their own BSIC transmissions. Let us further assume that these BSIC transmissions do not overlap in time, and that said four GSM base stations are close enough to each other so that a mobile terminal currently communicating with a base station of a UTRAN should receive the BSIC transmissions from each of the four GSM base stations. Compressed mode must be used, so that there are enough transmission gaps for the mobile terminal to receive the BSIC transmissions. According to the timing considerations given above and the assumption of non-overlapping BSIC transmissions, a network element in the UTRAN may fix five frame durations, i.e. a 50 ms time period from the near future and select expected BSIC transmissions from the four GSM base stations so that they all occur within the fixed period of 50 ms. These BSIC transmissions are schematically shown in FIG. 3 as 301, 302, 303 and 304. Note that FIG. 3 exaggerates the temporal duration of each BSIC message; for the following considerations it suffices to assume that their starting points (the left-hand edges of the blocks shown in FIG. 3) are located correctly.

The next task of the network element in the UTRAN is to compose a transmission gap pattern sequence where the transmission gaps coincide with the BSIC transmissions 301, 302, 303 and 304. In the example of FIG. 3 it is possible to compose a sequence that consists of only two occurrences of a transmission gap pattern by setting the value of the #TGPRC parameter to be two. The length of the first transmission gap pattern becomes 20 ms (TGPL1=2) and the length of the second transmission gap pattern becomes 30 ms (TGPL2=3). If the network element had to use the prior art method where the values of TGSN, TGL1, TGL2 and TGD are the same in both transmission gap patterns, it could not accommodate gaps into the sequence so that the mobile terminal could receive all four BSIC transmissions, except in the very rare special case where the distance in slots between the beginning of the first transmission gap pattern and the first BSIC transmission 301 would be exactly the same as the distance between the beginning of the second transmission gap pattern and the third BSIC transmission 303, and the distance in slots between the first 301 and second 302 BSIC transmissions would be exactly the same as the distance between the third 303 and fourth 304 BSIC transmissions.

According to the invention the network element sets the value of the #TGPRC parameter to be two and the values of the TGPL1 and TGPL2 parameters to be two and three respectively. It sets the value of the TGSN1 parameter to be equal to the largest possible number of slots between the beginning of the first transmission gap pattern and the first BSIC transmission 301, and the value of the TGSN2 parameter to be equal to the largest possible number of slots between the beginning of the second transmission gap pattern and the third BSIC transmission 303. Here “largest possible” is understood so that when the transmission gap begins after this number of transmission slots, the mobile terminal still has sufficient time to prepare for the reception of a BSIC transmission during the gap. Similarly the network element sets the value of the TGD1 parameter to be equal to the largest possible number of slots between the beginning of the first transmission gap and the second BSIC transmission 302, and the value of the TGD2 parameter to be equal to the largest possible number of slots between the beginning of the second transmission gap and the fourth BSIC transmission 303.

Note that the length of the transmission gap pattern sequence need not be exactly five UTRA FDD frame periods. Even if we hold on to the assumption that gaps should be provided for the reception of exactly four BSIC transmissions, it may happen that these are so close together in time that the length of the transmission gap pattern sequence can be four UTRA FDD frame periods or even less. Especially if the number of BSIC transmissions to be received is decreased from four, it is possible to decrease the length of the transmission gap pattern sequence towards a minimum of one UTRA FDD frame period (consisting of only one transmission gap pattern, and accommodating gaps for the reception of a maximum of two BSIC transmissions). There is no maximum limit to the length of the transmission gap pattern sequence, but since it is possible to map all BSIC transmissions into a period of 50 ms, and since the TGPL1, TGPL2, TGSN1, TGSN2, TGD1 and TGD2 are the same throughout the transmission gap pattern sequence, it is seldom advantageous to make the transmission gap pattern sequence longer than five frame periods.

Note also that improvement over the prior art arrangement is achieved already by letting only one of the TGSN and TGD parameters to change value between the transmission gap patterns. Namely, let us consider a situation where there are three BSIC transmissions to be received. According to prior art, their reception would have required two different transmission gap pattern sequences to be composed and signalled to the mobile terminal. According to the invention one transmission gap pattern sequence is enough. Placing three transmission gaps at arbitrary locations (with the resolution of one slot) within a sequence of two transmission gap patterns requires three slot-wise determined parameter values to be selected: according to the invention, possible combinations are TGSN1, TGD1 and TGSN2; TGSN1, TGD1 and TGD2; TGSN1, TGSN2 and TGD2; and TGD1, TGSN2 and TGD2.

FIG. 4 illustrates the operation of the network element in the form of a flow diagram.

As soon as the network element learns that a mobile terminal needs to receive BSIC transmissions, it exits the loop consisting of step 401 and gets the appropriate BSIC transmission timetables at step 402. It checks at step 403, whether there are four non-overlapping BSIC transmissions that can be mapped into a suitable period of time, the length of said period advantageously not exceeding 50 ms. Mapping is taken to mean the selection of an individual BSIC transmission from expected repeated occurrences of BSIC transmissions so that the expected occurrence in time of the selected individual BSIC transmission is well known and within a desired, fixed time period in the near future.

If four non-overlapping expected BSIC transmissions are found, they are all chosen at step 404. If not, the network element chooses as many non-overlapping expected BSIC transmissions as it can at step 405. At step 406 it fixes the time period in question in the near future so that enough time is left before it for finishing calculations and signalling the transmission gap pattern sequence information to the mobile terminal. Algorithms for fixing a time period are known as such for example from the context of the prior art arrangements for signalling the parameters of transmission gap pattern sequences. At step 406 the network element also maps the chosen BSIC transmissions into the fixed time period.

At step 407 the network element derives the parameter values that are to describe the transmission gap pattern sequence meant for receiving the chosen BSIC transmissions, and at step 408 it signals the parameter values to the mobile terminal and the base station with which the mobile terminal is communicating. Signalling can be performed according to the principles known from prior art, although the number of parameters to be signalled is now slightly larger. After the signalling step the network element checks at step 409, whether there were left such BSIC transmissions that have not yet been mapped into a transmission gap pattern sequence. In a positive case it returns to step 403 to choose among the remaining ones, and if none are left the network element returns from step 409 to step 401.

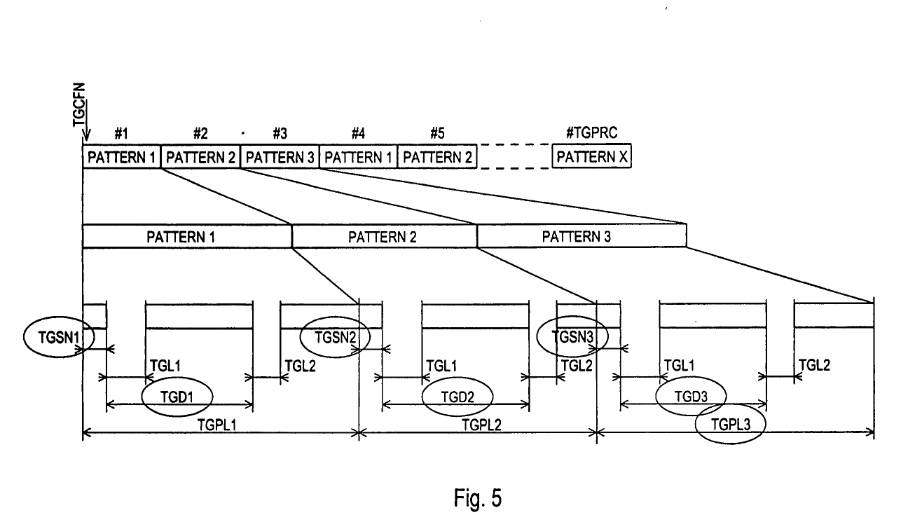

The embodiments of the invention described so far show how up to four transmission gaps can be placed freely (at the resolution of one slot, i.e. 667 microseconds) into a transmission gap pattern sequence. However, the idea of the invention can be extrapolated in the way shown in FIG. 5. Here there is defined, in a way analogous to the prior art definition of two alternately used transmission gap patterns, a total of three transmission gap patterns that fill the transmission gap pattern sequence in a cyclically repeating manner. In addition to the parameters TGPL1 (Transmission Gap Pattern Length 1) and TGPL2 (Transmission Gap Pattern Length 2) that denote the lengths in time of the first and second transmission gap patterns respectively, there is defined a parameter TGPL3 (Transmission Gap Pattern Length 3) that denotes the length in time of the third transmission gap pattern. All transmission gap pattern lengths are given in numbers of frames, and the values of TGPL2 and TGPL3 are equal to that of TGPL1 if not explicitly stated otherwise. The durations of the first and second transmission gaps within each transmission gap pattern are again given by the values of the TGL1 and TGL2 parameters respectively, and expressed in number of slots. The value of TGL2 is equal to that of TGL1 if not explicitly stated otherwise.

The new parameters in FIG. 3 that introduce slot-wise timing resolution for fifth and sixth independently placed transmission gaps in the sequence are TGSN3 (Transmission Gap Starting slot Number 3) and TGD3 (Transmission Gap Distance 3). From the above-given description of FIGS. 2 and 3 it is easy to deduce, how their existence allows up to six independent BSIC transmissions to be received during a simple transmission gap pattern sequence that consists of single consecutive occurrences of all three transmission gap patterns. Note that the use of three transmission gap patterns does not necessarily make the timeframe of 50 ms referred to in FIG. 3 longer, if the length of at least one transmission gap pattern is only one UTRA FDD frame.

In principle it would be possible to continue extrapolating to four, five or even more independently defined transmission gap patterns in a sequence. However, the number of three transmission gap patterns shown in FIG. 5 is important, because the corresponding number of six independently defined transmission gaps happens to equal the GSM-specified maximum number of six BSIC transmissions to be received and reconfirmed by a single mobile terminal.

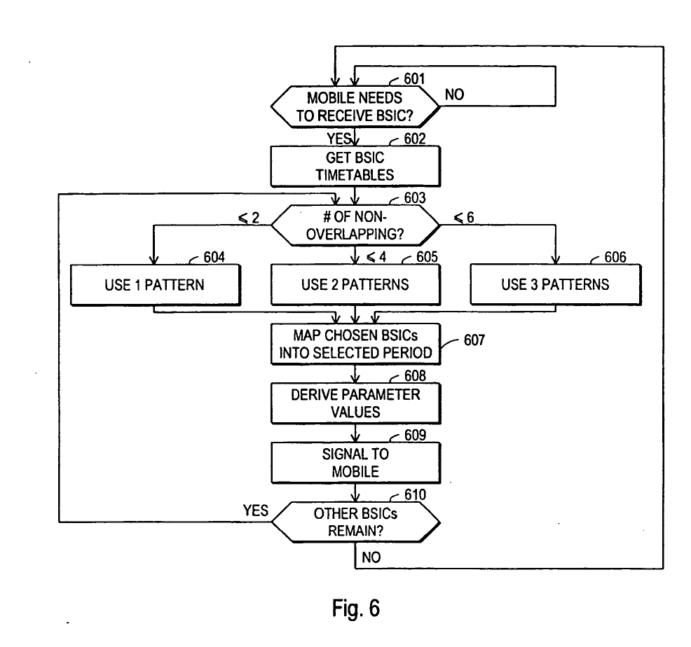

FIG. 6 illustrates a modification of the method shown earlier in FIG. 4. Steps 601 and 602 are the same as steps 401 and 402 respectively in FIG. 4. At step 603 the network element examines, how many non-overlapping BSICs it could map into a transmission gap pattern sequence. If the number of such non-overlapping BSICs is not greater than two, the network element selects only one transmission gap pattern to appear in the sequence at step 604. If the number of non-overlapping BSICs is three or four, the network element selects two transmission gap patterns to appear in the sequence at step 605. If the number of non-overlapping BSICs is five or six, the network element selects three transmission gap patterns to appear in the sequence at step 606. After having selected the number of transmission gap patterns the network element fixes the time period for the transmission gap pattern sequence and performs the mapping at step 607. Steps 608, 609 and 610 are the same as steps 407, 408 and 409 respectively in FIG. 4, with the exception that the number or parameters to be signalled at step 609 may now vary more than previously at step 408, because it is possible to use even three different transmission gap patterns.

The following table summarizes certain features of the parameters described so far, as well as certain additional parameters that can be used together with the above-described ones.

| Information Element/ | | |
|---|---|---|
| Group name | Type and reference | Semantics description |
| TGCFN | Integer (0 . . . 255) | Connection Frame Number of the |
| | | first frame of the first pattern within |
| | | the Transmission Gap Pattern Sequence. |
| TGMP | Enumerated (TDD | Transmission Gap pattern sequence |
| | measurement, FDD | Measurement Purpose. |
| | measurement, GSM | |
| | carrier RSSI measurement, | |
| | GSM Initial | |
| | BSIC identification, | |
| | GSM BSIC reconfirmation) | |
| TGPRC | Integer (1 . . . 63, Infinity) | The number of transmission gap |
| | | patterns within the Transmission Gap |
| | | Pattern Sequence. |
| TGSN1 | Integer (0 . . . 14) | Transmission Gap Starting Slot |
| | | Number 1. |
| | | The slot number of the first transmission |
| | | gap slot within the first pattern. |
| TGSN2 | Integer (0 . . . 14) | Transmission Gap Starting Slot |
| | | Number 2. |
| | | The slot number of the first transmission |
| | | gap slot within the second pattern. |
| | | If omitted, then TGSN2 = TGSN1. |
| TGSN3 | Integer (0 . . . 14) | Transmission Gap Starting Slot |
| | | Number 3. |
| | | The slot number of the first transmission |
| | | gap slot within the third pattern. |
| | | If omitted, then TGSN3 = TGSN1. |
| TGL1 | Integer (1 . . .14) | The length of the first Transmission |
| | | Gap within the transmission gap |
| | | pattern expressed in number of slots |
| TGL2 | Integer (1 . . . 14) | The length of the second Transmission |
| | | Gap within the transmission gap |
| | | pattern. If omitted, then |
| | | TGL2 = TGL1. |
| TGD1 | Integer (15 . . . 269, | Transmission gap distance indicates |
| | undefined) | the number of slots between starting |
| | | slots of two consecutive transmission |
| | | gaps within transmission gap pattern |
| | | 1. If there is only one transmission |
| | | gap in the transmission gap pattern, |
| | | this parameter shall be set to “undefined”. |
| TGD2 | Integer (15 . . . 269, | Transmission gap distance indicates |
| | undefined) | the number of slots between starting |
| | | slots of two consecutive transmission |
| | | gaps within transmission gap pattern |
| | | 2. If there is only one transmission |
| | | gap in the transmission gap pattern, |
| | | this parameter shall be set to “undefined”. |
| | | If omitted, then TGD2 = “undefined”. |
| TGD3 | Integer (15 . . . 269, | Transmission gap distance indicates |
| | undefined) | the number of slots between starting |
| | | slots of two consecutive transmission |
| | | gaps within transmission gap pattern |
| | | 3. If there is only one transmission |
| | | gap in the transmission gap pattern, |
| | | this parameter shall be set to “undefined”. |
| | | If omitted, then TGD3 = “undefined”. |
| TGPL1 | Integer (1 . . . 144) | The duration of transmission gap |
| | | pattern 1. |
| TGPL2 | Integer (1 . . . 144) | The duration of transmission gap |
| | | pattern 2. If omitted, then |
| | | TGPL2 = TGPL1. |
| TGPL3 | Integer (1 . . . 144, | The duration of transmission gap |
| | undefined) | pattern 3. If omitted, then |
| | | TGPL3 = “undefined”, ie. no pattern 3 |
| | | is used. |
| RPP | Enumerated (mode 0, | Recovery Period Power control mode |
| | mode 1). | during the frame after the transmission |
| | | gap within the compressed |
| | | frame. Indicates whether normal PC |
| | | mode or compressed PC mode is applied |
| ITP | Enumerated (mode 0, | Initial Transmit Power is the uplink |
| | mode 1). | power control method to be used to |
| | | compute the initial transmit power |
| | | after the compressed mode gap. |
| UL/DL mode | Enumerated (UL only, | Defines whether only DL, only UL, |
| | DL only, UL/DL) | or combined UL/DL compressed |
| | | mode is used. |

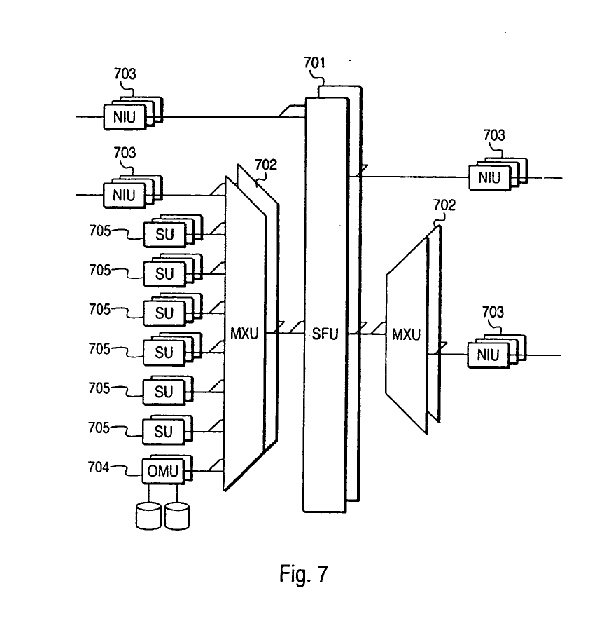

The network element that performs the routine described above is typically a radio network controller (RNC). FIG. 7 defines a functional structure of a typical RNC of a cellular radio network, more exactly of a UTRAN utilizing WCDMA. The invention must naturally not be considered to be limited thereto. The invention can also be used in other types of cellular radio networks.

The RNC of FIG. 7 comprises a SFU (Switching Fabric Unit) 701 to which several control processor units can be connected. Reliability is typically enhanced by providing hardware level redundancy in the form of parallel redundant units. MXUs (Multiplexing Units) 702 can be used between a number of processor units and the SFU 701 to map the low bitrates from the processor units into the high bitrates of the SFU input ports. The NIUs (Network Interface Units) 703 handle the physical layer connection to different interfaces (e.g. Iub interface towards Node B:s, Iur interface towards other RNCs, Iu interface towards core network nodes). The OMU (Operations and Maintenance Unit) 704 contains the RNC configuration and fault information and can be accessed from an external operations and maintenance center. The SUs (Signalling Units) 705 implement all the control and user plane protocols required in the RNC. Thus, the invention can be implemented in RNC in the Signalling Units by providing therein the algorithms that implement the method described above in association with FIGS. 4 and 6. Making the Signalling Units perform certain algorithms is known as such, because also the prior art arrangement of FIG. 1 required certain algorithms to be performed therein.

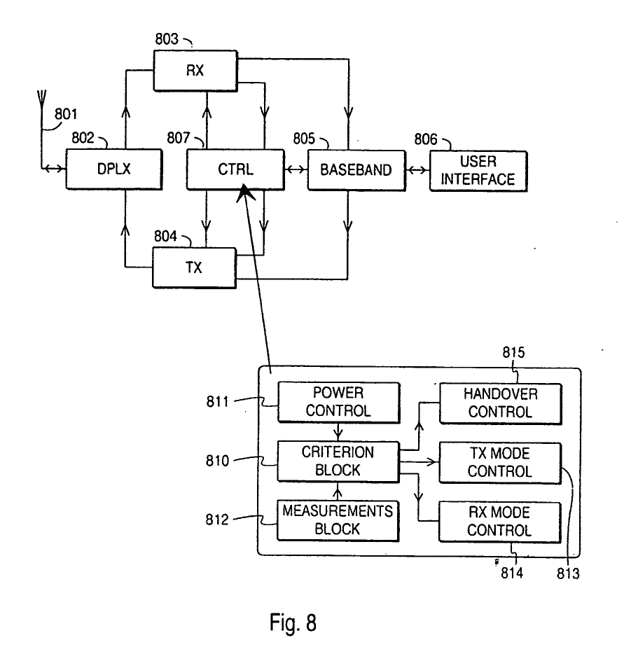

FIG. 8 illustrates schematically certain parts of a mobile terminal according to an embodiment of the invention. An antenna 801 is coupled through a duplexing block 802 to a receiver block 803 and a transmitter block 804. The sink of payload data from the receiver block 803 and the source of payload data to the transmitter block 804 is a baseband block 805 which in turn is coupled to a user interface block 806 for communicating with a human or electronic user. A control block 807 receives control information from the receiver block 803 and transmits control information through the transmitter block 804. Additionally the control block 807 controls the operation of the blocks 803, 804 and 805.

In accordance with the invention, the control block 807 comprises a criterion block 810 that contains the criteria that, together with the results from a power control block 811 and a measurement block 812, define which transmission mode should be set by the transmission mode control block 813, which reception mode should be set by the reception mode control block 814 and when the handover control block 815 should be called to perform a handover. One part of the input that the criterion block 810 receives in signalling transmissions from the network is constituted by the parameter sets that convey the compressed mode information. The TGCFN parameter conveys the starting criterion of a certain transmission gap pattern sequence, and the other parameters described above convey the various timing factors. In accordance with the invention the criterion block 811, the transmission mode control block 813 and the reception mode control block 814 are together arranged to control the operation of the mobile terminal during compressed mode so that the transmission gaps are held and BSIC reception is accomplished at the appropriate moments determined by the parameter values.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

1. A method for indicating (408, 609) the timing of a transmission gap pattern sequence to a mobile terminal of a cellular radio system, comprising the steps of:
indicating (408, 609) a starting moment (TGCFN) of the transmission gap pattern sequence,
indicating (408, 609) a total number of occurrences (#TGPRC) of transmission gap patterns in the transmission gap pattern sequence,
indicating (408, 609) lengths of certain first (TGPL1) and second (TGPL2) transmission gap patterns that are to occur during the transmission gap pattern sequence, and
indicating (408, 609) lengths of transmission gaps (TGL1, TGL2) to be located within the first and second transmission gap patterns;
characterized in that it comprises the step of indicating (408, 609) three of the following independently of each other:
a) a distance (TGSN1) between a beginning of the first transmission gap pattern and a beginning of a temporally first transmission gap within the first transmission gap pattern,
b) a distance (TGSN2) between a beginning of the second transmission gap pattern and a beginning of a temporally first transmission gap within the second transmission gap pattern,
c) a distance (TGD1) between beginnings of certain temporally first and temporally second transmission gaps within the first transmission gap pattern, and
d) a distance (TGD2) between beginnings of certain temporally first and temporally second transmission gaps within the second transmission gap pattern.

2. A method according to claim 1, characterized in that it comprises the step of indicating (408, 609) all four of a), b), c) and d) independently of each other.

3. A method according to claim 1, characterized in that it comprises the steps of:
indicating (408, 609) a length of a certain third (TGPL3) transmission gap pattern that is to occur during the transmission gap pattern sequence, and
indicating (408, 609) five of the following independently of each other:
a) the distance (TGSN1) between the beginning of the first transmission gap pattern and the beginning of a temporally first transmission gap within the first transmission gap pattern,
b) the distance (TGSN2) between the beginning of the second transmission gap pattern and the beginning of a temporally first transmission gap within the second transmission gap pattern,
c) the distance (TGD1) between beginnings of certain temporally first and temporally second transmission gaps within the first transmission gap pattern,
d) the distance (TGD2) between beginnings of certain temporally first and temporally second transmission gaps within the second transmission gap pattern,
e) a distance (TGSN3) between a beginning of the third transmission gap pattern and a beginning of a temporally first transmission gap within the third transmission gap pattern, and
f) a distance (TGD3) between beginnings of certain temporally first and temporally second transmission gaps within the third transmission gap pattern.

4. A method according to claim 3, characterized in that it comprises the step of indicating (408, 609) all six of a), b), c), d), e) and f) independently of each other.

5. A method according to claim 1, characterized in that it comprises the steps of:
observing (401, 601) a need of a mobile terminal for receiving basic station identity code (BSIC) transmissions from certain base stations of a global system for mobile telecommunications (GSM) system,
obtaining (402, 602) timetables of BSIC transmissions from the certain base stations of the GSM system,
fixing (406, 607) a certain time period to come,
composing (403, 404, 405, 406, 603, 604, 605, 606, 607) a transmission gap pattern sequence that comprises certain transmission gaps into which certain expected BSIC transmissions from a base station of a GSM system are mapped, so that when the transmission gap pattern sequence is executed during the fixed time period to come, the transmission gaps coincide with expected BSIC transmissions from the certain base stations of the GSM system, and
indicating (408, 609) timing of a composed transmission gap pattern sequence to a mobile terminal.

6. A method according to claim 5, characterized in that the step of observing (401, 601) the need of a mobile terminal for receiving BSIC transmissions corresponds to observing a need of the mobile terminal for BSIC reconfirmation.

7. An arrangement for defining the timing of a transmission gap pattern sequence for a mobile terminal of a cellular radio system, comprising:
means (705) for defining a starting moment (TGCFN) of the transmission gap pattern sequence,
means (705) for defining a total number of occurrences (#TGPRC) of transmission gap patterns in the transmission gap pattern sequence,
means (705) for defining lengths of certain first (TGPL1) and second (TGPL2) transmission gap patterns that are to occur during the transmission gap pattern sequence, and
means (705) for defining lengths of transmission gaps (TGL1, TGL2) to be located within the first and second transmission gap patterns;
characterized in that it comprises means (705) for defining at least three of the following independently of each other:
a) a distance (TGSN1) between a beginning of the first transmission gap pattern and a beginning of a temporally first transmission gap within the first transmission gap pattern,
b) distance (TGSN2) between a beginning of the second transmission gap pattern and a beginning of a temporally first transmission gap within the second transmission gap pattern,
c) distance (TGD1) between beginnings of certain temporally first and temporally second transmission gaps within the first transmission gap pattern, and
d) distance (TGD2) between beginnings of certain temporally first and temporally second transmission gaps within the second transmission gap pattern.

8. An arrangement according to claim 7, characterized in that it comprises:
means (705) for defining a length of a certain third (TGPL3) transmission gap pattern that is to occur during the transmission gap pattern sequence, and
means (705) for defining at least five of the following independently of each other:
a) the distance (TGSN1) between the beginning of the first transmission gap pattern and the beginning of a temporally first transmission gap within the first transmission gap pattern,
b) the distance (TGSN2) between the beginning of the second transmission gap pattern and the beginning of a temporally first transmission gap within the second transmission gap pattern,
c) the distance (TGD1) between the beginnings of certain temporally first and temporally second transmission gaps within the first transmission gap pattern,
d) the distance (TGD2) between the beginnings of certain temporally first and temporally second transmission gaps within the second transmission gap pattern,
e) a distance (TGSN3) between a beginning of the third transmission gap pattern and a beginning of a temporally first transmission gap within the third transmission gap pattern, and
f) a distance (TGD3) between beginnings of certain temporally first and temporally second transmission gaps within the third transmission gap pattern.

9. An arrangement for observing the timing of a transmission gap pattern sequence in a mobile terminal of a cellular radio system, comprising:
means (810, 813, 814) for observing a starting moment (TGCFN) of the transmission gap pattern sequence,
means (810, 813, 814) for observing a total number of occurrences (#TGPRC) of transmission gap patterns in the transmission gap pattern sequence,
means (810, 813, 814) for observing lengths of certain first (TGPL1) and second (TGPL2) transmission gap patterns that are to occur during the transmission gap pattern sequence, and
means (810, 813, 814) for observing lengths of transmission gaps (TGL1, TGL2) to be located within the first and second transmission gap patterns;
characterized in that it comprises means (810, 813, 814) for observing at least three of the following independently of each other:
a) a distance (TGSN1) between a beginning of the first transmission gap pattern and the beginning of a temporally first transmission gap within the first transmission gap pattern,
b) a distance (TGSN2) between a beginning of the second transmission gap pattern and a beginning of a temporally first transmission gap within the second transmission gap pattern,
c) the distance (TGD1) between beginnings of certain temporally first and temporally second transmission gaps within the first transmission gap pattern, and
d) a distance (TGD2) between beginnings of certain temporally first and temporally second transmission gaps within the second transmission gap pattern.

10. An arrangement according to claim 9, characterized in that it comprises:
means (810, 813, 814) for observing a length of a certain third (TGPL3) transmission gap pattern that is to occur during the transmission gap pattern sequence, and
means (810, 813, 814) for observing at least five of the following independently of each other:
a) the distance (TGSN1) between the beginning of the first transmission gap pattern and the beginning of the temporally first transmission gap within the first transmission gap pattern,
b) the distance (TGSN2) between the beginning of the second transmission gap pattern and the beginning of the temporally first transmission gap within the second transmission gap pattern,
c) the distance (TGD1) between the beginnings of certain temporally first and temporally second transmission gaps within the first transmission gap pattern,
d) the distance (TGD2) between the beginnings of certain temporally first and temporally second transmission gaps within the second transmission gap pattern,
e) a distance (TGSN3) between a beginning of the third transmission gap pattern and a beginning of a temporally first transmission gap within the third transmission gap pattern, and
f) a distance (TGD3) between beginnings of certain temporally first and temporally second transmission gaps within the third transmission gap pattern.
